(19) United States
(12) Patent Application Publication
(10) Pub. No.: US 2006/0117573 A1
(43) Pub. Date: Jun. 8, 2006

(54) Apparatus and method for guiding a tool along a path on a surface

(75) Inventors: Kim Stanley Jensen, Frederikssund (DK); Jan Thybo Kjaer, Hadsten (DK); Freddy G. Sorensen, Vedbaek (DK); Palle Sorensen, Gislev (DK)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: MOBILGLAS 2000APS, GENTOFTE (DK)

(21) Appl. No.: 10/523,997

(22) PCT Filed: Aug. 7, 2003
(86) PCT No.: PCT/DK03/00530

§ 371 Date: Oct. 26, 2005

Related U.S. Application Data
(60) Provisional application No. 60/402,051, filed on Aug. 9, 2002.

(30) Foreign Application Priority Data
Aug. 9, 2002 (DK) PA 2002 01197

(51) Int. Cl. B26B 29/00

(52) U.S. Cl. 30/286

(57) ABSTRACT

Tool guiding apparatus for guiding a tool along a path on a surface to be processed, said apparatus comprising at least one path-defining means adapted to be attached to the surface, automatic tool actuating means adapted to advance the tool along the path. Wherein the automatic tool actuation means comprises a flexible force-transferring element comprising a first end and a second end, the first end being attached to the automatic tool actuation means and the second end being attached to the tool.

### FIELD OF THE INVENTION

The present invention relates to an apparatus for guiding a tool along a path, in particular to an apparatus for cutting a compound between a windscreen and an automobile. Furthermore, the invention relates to a method of cutting a path along a predetermined line, in particular to a method for guiding a knife along a compound between a windscreen and an automobile.

### BACKGROUND OF THE INVENTION

Windscreens are glued to the automobile by means of a strong compound or glue. For many years car manufacturers have improved the glue so as to ensure a strong and binding connection. One reason for this is that windscreens today are load-bearing elements. Unfortunately, the windscreens need to be replaced from time to time. This is due to holes or scratches made by thrown-up pebbles. Concurrently with the improved glue or compound the windscreens are becoming harder to remove. Three general principles for removing the glue are known. The three principles are oscillating knives, cold knives and cutting wires.

The use of each of three principles provide working conditions which over time may result in working related injuries. For the user the oscillating knives are the easiest to use as the force needed to be applied is low as the oscillating knives cut their way through the glue. However, over time the vibrating nature of the oscillating knife may cause Raynaud Syndrome. Furthermore, the use of the oscillating knife requires that the user wear a hearing protection. As such hearing protecting must be taking on and off several times during the day, many users omit using the hearing protection. Over time this results in hearing damages.

Cold knives and the cutting wires require a considerable amount of force to use and as the working position of the user is awkward the use of these tools over time may result in back injuries. U.S. Pat. No. 3,924,327 discloses a solution to this problem by providing a power supplied force transferring means e.g. an air-hammer. Like the oscillating knife the force transferring means has a vibrating nature which may over time result in Raynaud Syndrome.

U.S. Pat. No. 4,819,531 discloses a cutting tool comprising a blade and a winch assembly. A wire connected to the winch assembly is secured to a part of the automobile and thus the user may only steer the blade with one hand as the other must be used to operate the winch.

Furthermore, manipulation of the winch lever transmits force to the blade. As the force constantly changes direction and intensity the steering of the blade is complicated even further.

WO 86/07017 discloses an apparatus comprising a cutting wire for dismounting a windscreen, where the cutting wire is arranged along the glue joint of the windscreen. The cutting wire of this apparatus is drawn by a drawing device, which may incorporate a motor. The apparatus comprises a movable guide for guiding the cutting wire. The cutting wire must be strong enough to withstand the considerable force necessary to cut the glue joint of the windscreen, which means that the wire must have a relatively large cross-section. To be able to cut the glue joint, however, the wire must have a very small cross-section, and it is difficult to achieve a compromise between these conflicting requirements. Further there is a risk that the cutting wire will disengage from the glue joint, especially at the corners of the windscreen, with potential risk of damage to the apparatus, the vehicle or even injury to the operator of the apparatus. Further it is not possible to guide the cutting wire with any kind of precision in the glue joint, hence there is a risk of damaging inter alia the paint of the vehicle. Furthermore the initial step of arranging the cutting wire through and around the glue joint is laborious. Finally the apparatus must be installed within the cabin of the vehicle where there is a limited working space which renders the installation difficult. With modern cars having very inclined windscreens, it may be almost impossible to have access to the lower inside corners.

### DESCRIPTION OF THE INVENTION

It is an object of the present invention to provide an apparatus and a method which overcome the above mentioned disadvantages. Thus the present invention relates to a tool guiding apparatus for guiding a tool along a path on a surface to be processed, said apparatus comprising:

at least one path-defining means adapted to be attached to the surface, automatic tool actuation means adapted to advance the tool along the path, wherein the automatic tool actuation means comprises a flexible force-transferring element comprising a first end and a second end, the first end being attached to the automatic tool actuation means and the second end being attached to the tool.

The tool may be guided along a plurality of straight lines but could also be guided along curves such as semicircles or a s-curve or a hyperbola or any other curve. The path may be a combination of curves and straight lines. The path defining means may be attached to the surface to be processed but could also be attached to a surface adjacent to the surface to be processed. E.g. the path defining means may be attached to a windscreen so as to enable cutting of glue between a windscreen and the frame of a car. The path defining means may also be attached to a panel or a plate to be cut. At least a part of the path defining means may be shaped so as to follow at least a part of the curve to be followed by the tool. The path defining means may comprise a structure such as a frame which is adapted to guide the tool along the path to be followed.

By automatic tool actuation means is meant means which advances the tool without application of force by the user during operation. Thus the user may devote force and attention to steering and guiding, resulting in improved quality of the work done by the tool. The automatic tool actuation means may be means which during operation requires external supply of energy such as fuel or electricity, but the means may also be means which must be charged with energy prior to use. E.g. the means may be a spring such as a helical spring which must be turned prior to use of the device so as to be able to transfer energy to the tool.

The first end of the flexible force transferring element may be attached to a wheel on the automatic tool actuation means, which is adapted to reel in the flexible force-transferring element. The force-transferring element may be a wire or a chain or a belt. The flexible force-transferring element may be flexible in only one plane but could also be flexible in two planes or in any direction. If the flexible force-transferring element is flexible in two planes, the two planes may be substantially perpendicular to each other.

The path-defining means may be adapted to engage at least a part of the flexible force-transferring element. By engaging the force-transferring element the path-defining means defines the path which the tool is to follow. The path defining means may be a curved surface along which the force-transferring element may be provided. As an example the path defining means may be a semi-circular surface along which a belt is provided. The belt and the surface may have low frictional properties so as to enable pulling the belt along the surface. If the force transferring element is a chain the path-defining means may be provided with a toothed wheel which engages the chain. The toothed wheel may make it possible to pull the chain and may steer the chain in a direction substantially parallel to the axis of rotation of the wheel.

In an embodiment the path-defining means may comprise a wheel adapted to engage at least a part of the force-transferring element. If the force-transferring element is a belt, the wheel may be provided with flanges on each side of the wheel so as to steer the belt in a direction substantially parallel to the axis of rotation of the wheel. In an embodiment the wheel and the force transferring element is provided with magnets so as to steer the belt in a direction substantially parallel to the axis of rotation of the wheel.

Furthermore, the automatic tool actuation means may be adapted to be attached to the surface to be processed. Both the path defining means and the force transferring element may, at the same time, be attached to the surface to be processes or a surface adjacent to the surface to be processed. In an embodiment the path defining means may be attached to the windscreen while the actuation means is attached to the same windscreen. Alternatively the path defining means may be attached to the roof or a side of a car while the actuation means may be attached to the windscreen or vice versa. The automatic actuation means may be attached to a wall or a ceiling or a structure placed adjacent to the item to be processed. As an example the actuation means may be attached to a frame. The frame may be provided with wheels so that it may be moved around in e.g. a workshop.

At least one of the automatic tool actuation means and the at least one path-defining means may comprise at least one vacuum cup and/or another means for attachment to the surface to be processed such as magnets provided on each side of the surface to be processed. In some embodiments at least a part of the path-defining means or the automatic tool actuation means is attached to the surface to by processed by means of glue or screws or nails or welding or Velcro® tape.

In an embodiment the path defining means and/or the actuation means may each be provided with one vacuum cup, but could also be provided with a plurality of vacuum cups such as two or three or four or five or six or seven or eight or nine or ten. The diameter of the vacuum cups may be 2 cm or 3 cm or 4 cm or 5 cm or 6 cm or 7 cm or 8 cm or 9 cm or 10 cm or 11 cm or 12 cm or 13 cm or 14 cm or 15 cm or 16 cm or 17 cm or 18 cm or 19 cm or 20 cm or 25 cm or 30 cm or 35 cm or 45 cm or 50 cm. If the path defining means and/or the actuation means is provided with more than one vacuum cup, said cups may be provided in different sizes. The vacuum cup(s) may be connected to a vacuum pump for easy mounting of the vacuum cup(s) on a surface.

The tool may comprise a knife with a cutting edge such as a cold-knife. Furthermore, the tool to be guided may be a saw e.g. a compass saw or a circular saw, but could also be a shuffle sander or an eccentric sander or a machine for polishing or an welding apparatus or a blowtorch or a diamond cutter or a laser cutter or a painting device or an oscillating knife or a plate shears such as automated plate shears.

The knife may be provided with means for generating heat so as to elevate the temperature of the cutting blade. The knife may be provided with a plurality of blades such a two or three or four or five. A plurality of knives may also be provided. The blade(s) of the knife(s) may be changeable so that the same fixture may be used with different blades of the same kind or blades of different types such as straight blades, serrated blades, curved blades etc. The blades or the knife may be provided with means for applying a friction-reducing means to the cutting zone. E.g. in one embodiment the blade is provided with holes through which liquid is applied. The liquid may be oil or sulphone or soap or water.

At least a part of the cutting edge may extend in a direction transverse to a line defined by at least a part of the force-transferring element. The line may be defined by that part of the line, which is closest to the knife or tool. The cutting edge may extend in a direction substantially perpendicular to the said line.

In one embodiment the vacuum cup and the wheel may be interconnected by a moment arm. Thus the moment arm in one end may be provided with a vacuum cup and in the other end may be provided with the wheel. The moment arm may also be provided with a plurality of vacuum cups e.g. so that the arm in one end is provided with the wheel and along the arm is provided with a plurality of cups such as two or three or four or five or ten. The path defining means may also be provided with a plurality of moment arms each comprising at least one vacuum cup. E.g. the path defining means may comprise three moment arms each comprising a vacuum cup in one end and in the other end the moment arms may be connected to the same wheel. The latter embodiment may also be provided with two moment arms or four moment arms or five moment arms or six moment arms or ten moment arms.

The radius of the wheel may be substantially equal to the radius of a windscreen of an automobile. Thus the radii of the wheel and the windscreen do not necessarily have to be exactly equal but may vary a little. The radius of the wheel may be substantially equal to the radius of a corner of a windscreen so that the knife follows the edge of the windscreen, thus the knife may cut the glue between the windscreen and the frame of the automobile.

In one embodiment the wheel may be releasably attached to the path defining means. Thus it may be possible to remove the wheel and attach another wheel e.g. a new wheel or a wheel with a different radius or a wheel with different surface properties or a wheel with a different shape. The tool guiding apparatus may further comprise a plurality of interchangable wheels at least two of said wheels having different radii. The apparatus may comprise a plurality of wheels with different radii, so that a wheel with a radius substantially equal to the radius of the windscreen may be attached to the path-defining means.

At least a part of the surface of the wheel may comprise a friction increasing material. The friction may also be provided by a friction-increasing surface of the wheel. The friction-increasing surface and/or the friction increasing material may have a coefficient of static friction or a coefficient of dynamic friction of 0.1 or 0.2 or 0.3 or 0.4 or 0.5 or 0.6 or 0.7 or 0.8 or 0.9, cf. Engineering Mechanics volume 1, Statics, second edition, ISBN 0-471-84911-1, chapter 6 and appendix D.

At least a part of the force transferring element may comprise a friction increasing material. The friction may also be provided by a friction-increasing surface of the wheel. The friction-increasing surface and/or the friction increasing material may have a coefficient of static friction or a coefficient of dynamic friction of 0.1 or 0.2 or 0.3 or 0.4 or 0.5 or 0.6 or 0.7 or 0.8 or 0.9, cf. Engineering Mechanics volume 1, Statics, second edition, ISBN 0-471-84911-1, chapter 6 and appendix D.

In one embodiment the surface of the force transferring element and/or the wheel may comprise a Velcro® material so as to increase the friction between the force transferring element and the wheel. In other embodiments the friction may be provided by a sticky material such as glue.

The automatic tool actuation means comprises a motor. The motor may be an electric motor such as a DC motor or an AC motor. The motor may in some embodiments be a hydraulic motor or a pneumatic motor or a combustion engine. The motor may be electrical such as a motor which needs a power supply of 6 volts or 12 volts or 18 volts or 24 volts or 50 volts or 75 volts or 100 volts or 110 volts or 150 volts or 200 volts or 220 volts or 230 volts or 275 volts or 325 volts or 350 volts or 380 volts or 500 volts or 1000 volts. The motor may be able to provide an effect of 200 watt or 400 watt or 600 watt or 800 watt or 1000 watt or 1200 watt or 1400 watt or 1600 watt or 1800 watt or 2000 watt or 2200 watt or 2400 watt or 2600 watt or 2800 watt or 3000 watt or 5 kW or 7.5 kW or 10 kW or 20 kW. In one embodiment the electrical motor may comprise a plug for power supply which is adapted to the retrieve power from a moving vehicle such as a car or a truck e.g. the electrical motor may comprise an adapter for the cigarette lighter plug of a car, but it may also comprise means for retrieve power directly from a battery.

The automatic tool actuation means may be adapted to pull the tool along the path, and thus the force transferring element may rolled in on a wheel connected to the motor during operation of the apparatus.

The knife may be releasably attached to a fixture e.g. by means of screws. The fixture may comprise a means for activating the motor. E.g. so that by pressing a button the motor may be activated. In another embodiment the fixture comprises means which detect application of pressure from the fixture to the knife and upon such detection the motor may be activated. Furthermore, the means for activating the motor may be adapted to control the speed of the motor e.g. the fixture may comprise a button detecting difference in a force applied and upon said detection the speed of the motor may be varied. The speed may be constant or changed in steps or changed continuously.

The means for activating the motor may be wireless e.g. so that a button on the fixture is not in wired electrical connection with the motor. In other embodiments the button may be in wired electrical connection with the motor.

An apparatus according to the present invention may comprise control means for controlling the speed of the motor. Said means may control the speed in a predefined pattern e.g. so that the acceleration of the knife never exceeds a maximum value. Thus it may be possible to start the knife in a slow motion and accelerate the speed. This may improve the quality of the cut made by the knife.

According to a second aspect the invention relates to a method for guiding a tool along a path on a surface to be processed, said method comprising the steps of:

attaching at least one path defining means to the surface to be processed, and advancing the tool along the path by activating an automatic tool actuation means.

The path defining means may in one embodiment be attached to a surface adjacent to the surface to be processed. The tool may be advanced stepwise but could also be advanced in a continuous movement e.g. so that the speed is increased slowly until it reaches a desired maximum speed.

The method may further comprise the step of attaching the automatic tool actuation means to the surface. The path defining means may be attached prior to attaching the automatic tool actuation means and vice versa.

The invention according to the second aspect of the invention may comprise any feature or element of the first aspect of the invention.

### DETAILED DESCRIPTION OF THE INVENTION

Preferred embodiments of the invention will now be described in detail with reference to the drawing in which:

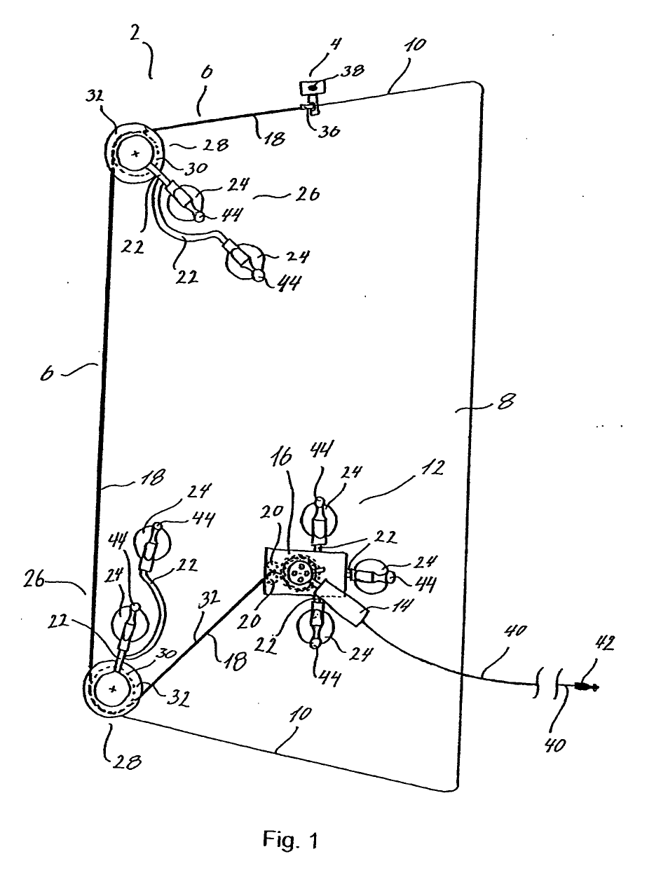

FIG. 1 shows an apparatus according to the first aspect of the invention,

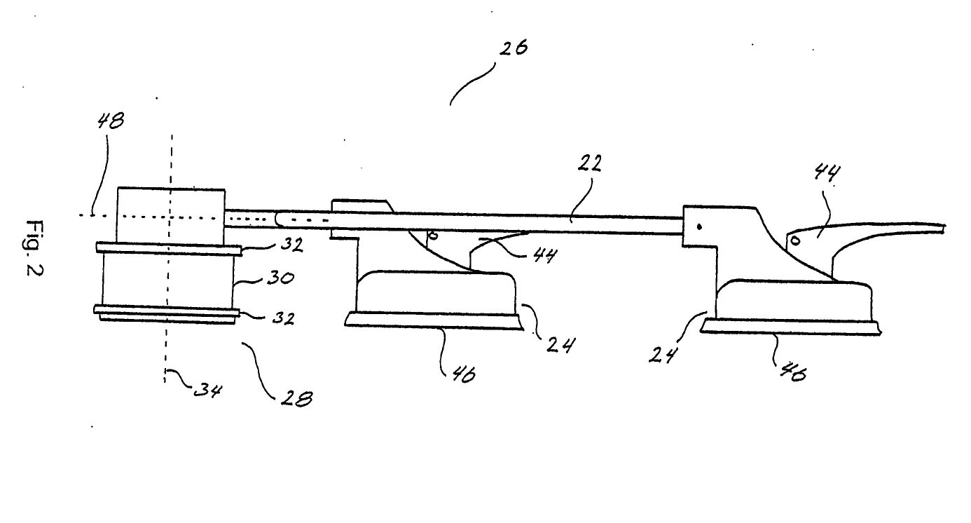

FIG. 2 shows a path defining means according to the invention and

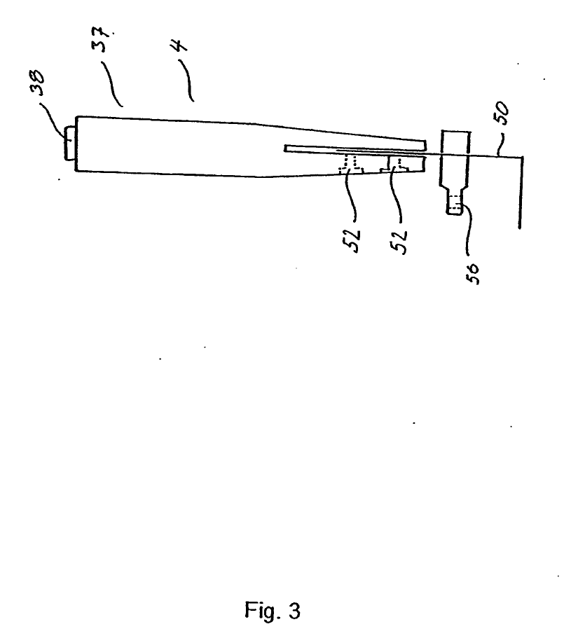

FIG. 3 shows a tool comprising a fixture and a knife according to the present invention.

Referring now to FIG. 1, the present invention relates to an apparatus 2 for guiding a tool 4 along a path 6. The apparatus is attached to a windscreen 8 which is attached to a car (not shown). The edge 10 of the windscreen 8 is glued to the car and the tool 4 is used to cut said glue. The apparatus comprises an automatic actuation means 12 comprising a motor 14 which is interconnected to a in-rolling-wheel 16 which rolls in a force-transferring element—here a belt 18—during operation of the apparatus 2. The automatic actuation means 12 comprises two positioning-wheels 20 which position the belt 18 in relation to the in-rolling-wheel 16. Furthermore, the automatic actuation means 12 comprises three moment arms 22 each of which is connected to a vacuum cup 24 in a first end and in a second end is connected to the motor 14. The apparatus 2 further comprises two path-defining means 26 each of which comprises a moment arm 22 in one end connected to a vacuum cup 24. In the other end the moment arm 22 is connected to a path-defining wheel 28. The wheel-surface 30 of the path-defining wheel 28 is covered with Velcro® tape at the same time the belt-surface 32 is also covered with Velcro® tape. Thus when the belt 18 is rolled in, the Velcro® tape positions the belt in relation to the wheel so that the belt 18 is not stripped off during operation. Furthermore the path-defining wheel 28 comprises flanges 32 which also positions the belt 18 in the axial direction 34 of the path-defining wheel 28. The belt 18 comprises a hook 36 which during operation is attached to the tool 4. The tool 4 comprises a button 38 for activating the motor 14. The motor 14 comprises a power supply cable 40 which is adapted to be connected to the cigarette lighter plug of a car by means of a plug 42.

FIG. 2 shows a path-defining means 26 comprising two vacuum cups 24 comprising handles 44 which is used to create a vacuum between the a buttom surface 46 and the windscreen 8. Furthermore the path-defining means 26 comprises a moment arm 22. In some embodiments the moment arm 22 is so long that it is possible to attach the path-defining means 26 to a surface of the windscreen which is substantially plane. This is desirable as it improves the ability of the vacuum cups 24 to maintain the vacuum. The wheel 28 may be pivotally connected to the moment arm 22 around the moment-arm-axis 48. The wheel-surface 30 has a surface which has high frictional properties e.g. the surface may be covered with Velcro® tape. Additionally the belt 18 is covered with Velcro® tape. The Velcro® tape may be provided on one side or on both sides of the belt 18 and on a part of the side(s) or on the entire side(s).

FIG. 3. shows the tool 4 comprising fixture 37 having a button 38 which is used to activate the motor 14. The tool may comprise a wire (not shown) connected to the motor, but may also comprise a transmitter for wireless activation of the motor 14. A knife 50 is attached to the fixture 37 and may be changed if the screws are removed. The tool 4 comprises a force transferring arm 54 comprising a hole 56 in which the hook may be inserted.

1. A tool guiding apparatus for guiding a tool along a path on a surface to be processed, said apparatus comprising:
at least one path-defining means adapted to be attached to the surface,
automatic tool actuation means adapted to advance the tool along the path, wherein the automatic tool actuation means comprises a flexible force-transferring element comprising a first end and a second end, the first end being attached to the automatic tool actuation means and the second end being attached to the tool.

2. A tool guiding apparatus according to claim 1, wherein the path-defining means is adapted to engage at least a part of the flexible force-transferring element.

3. A tool guiding apparatus according to claim 1, wherein the path-defining means comprises a wheel adapted to engage at least a part of the force-transferring element.

4. A tool guiding apparatus according to claim 1, wherein the automatic tool actuation means is adapted to be attached to the surface.

5. A tool guiding apparatus according to claim 4, wherein at least one of the automatic tool actuation means and the at least one path-defining means comprises at least one vacuum cup.

6. A tool guiding apparatus according to claim 1, wherein the tool is a knife with a cutting edge.

7. A tool guiding apparatus according to claim 6, wherein at least a part of the cutting edge extends in a direction transverse to a line defined by at least a part of the force-transferring element.

8. A tool guiding apparatus according to claim 5, wherein the vacuum cup and the wheel are interconnected by a moment arm.

9. A tool guiding apparatus according to claim 3, wherein the radius of the wheel is substantially equal to the radius of a windscreen of an automobile.

10. A tool guiding apparatus according to claim 3, wherein the wheel is releasably attached to the path defining means.

11. A tool guiding apparatus according to claim 3, further comprising a plurality of interchangeable wheels at least two of said wheels having different radii.

12. A tool guiding apparatus according to claim 5, wherein at least a part of the surface of the wheel comprises a friction increasing material.

13. A tool guiding apparatus according to claim 5, wherein at least a part of the force transferring element comprises a friction increasing material.

14. A tool guiding apparatus according to claim 1, wherein the automatic tool actuation means comprises a motor.

15. A tool guiding apparatus according to claim 14, wherein the motor is electrical.

16. A tool guiding apparatus according to claim 1, wherein the automatic tool actuation means are adapted to pull the tool along the path.

17. A tool guiding apparatus according to claim 6, wherein the knife is releasably attached to a fixture.

18. A tool guiding apparatus according to claim 6, wherein the fixture comprises a means for activating the motor.

19. A tool guiding apparatus according to claim 18, wherein the means for activating the motor is adapted to control the speed of the motor.

20. A tool guiding apparatus according to claim 18, wherein the means for activating the motor is wireless.

21. A tool guiding apparatus according to claim 14, further comprising control means for controlling the speed of the motor.

22. A method for guiding a tool along a path on a surface to be processed, said method comprising the steps of:
attaching at least one path defining means to the surface to be processed, and
advancing the tool along the path by activating an automatic tool actuation means.

23. A method according to claim 22, further comprising the step of attaching the automatic tool actuation means to the surface.
